(19) United States
(12) Patent Application Publication
(10) Pub. No.: US 2015/0339082 A1
(43) Pub. Date: Nov. 26, 2015

(54) HYBRID DOCUMENT PROCESSING OPERATION AGGREGATOR

(71) Applicants: Toshiba Tec Kabushiki Kaisha, Tokyo (JP); Kabushiki KaishaToshiba, Tokyo (JP)

(72) Inventor: Michael Yeung, Mission Viejo, CA (US)

(21) Appl. No.: 14/285,296

(22) Filed: May 22, 2014

(51) Int. Cl. G06F 3/12

(52) U.S. Cl. CPC G06F 3/126; G06F 3/1286

(57) ABSTRACT

Apparatus and methods for aggregating print operations are disclosed. A single login may be received via a user interface, the single login associated with a login database and automatically performing login operations using data stored in the login database for at least a network storage location and a network print queue. A search may be performed to identify print jobs stored in the network print queue and for stored documents available on the network storage location. The identified print jobs and stored documents may be displayed as an aggregate print queue. A user selection of a document from the aggregate print queue may be received, and print output of the selected document on a multifunction peripheral may be initiated.

### BACKGROUND

1. Field

This disclosure relates to performing document processing operations using public and private data sources and output locations.

2. Description of the Related Art

A multifunction peripheral (MFP) is a type of document processing device which is an integrated device providing at least two document processing functions, such as print, copy, scan and fax. In a document processing function, an input document (electronic or physical) is used to automatically produce a new output document (electronic or physical).

Documents may be physically or logically divided into pages. A physical document is paper or other physical media bearing information which is readable unaided by the typical human eye. An electronic document is any electronic media content (other than a computer program or a system file) that is intended to be used in either an electronic form or as printed output. Electronic documents may consist of a single data file, or an associated collection of data files which together are a unitary whole. Electronic documents will be referred to further herein as documents, unless the context requires some discussion of physical documents which will be referred to by that name specifically.

In printing, the MFP automatically produces a physical document from an electronic document. In copying, the MFP automatically produces a physical document from a physical document. In scanning, the MFP automatically produces an electronic document from a physical document. In faxing, the MFP automatically transmits via fax an electronic document from an input physical document which the MFP has also scanned or from an input electronic document which the MFP has converted to a fax format.

MFPs are often incorporated into corporate or other organization's networks which also include various other workstations, servers and peripherals. An MFP may also provide remote document processing services to external or network devices.

As reliance upon networks and the Internet has increased, the potential sources from which to draw documents for printing and to which to save documents produced from scanning has similarly increased. While printing from a computer to a multifunction peripheral remains the most common use case, users desire more flexibility and access to their documents directly from a multifunction peripheral or a mobile device.

### DESCRIPTION OF THE DRAWINGS

FIG. 1 is a diagram of an MFP system.

FIG. 2 is a block diagram of an MFP.

FIG. 3 is a block diagram of a computing device.

FIG. 4 is a block diagram of a software system for an MFP.

FIG. 5 is a block diagram of an aggregate queue software system.

FIG. 6 is a multifunction peripheral user interface showing a single sign on process.

FIG. 7 is a multifunction peripheral user interface showing available services as a result of the single sign on process.

FIG. 8 is a multifunction peripheral user interface showing an aggregate document processing operation queue.

FIG. 9 is a mobile device user interface showing an aggregate document processing operation queue.

FIG. 10 is a multifunction peripheral user interface showing send to locations.

FIG. 11 is a flowchart showing the process of aggregating print operations.

FIG. 12 is a flowchart showing the process of aggregating scan operations.

Throughout this description, elements appearing in figures are assigned three-digit reference designators, where the most significant digit is the figure number where the element is introduced, and the two least significant digits are specific to the element. An element that is not described in conjunction with a figure may be presumed to have the same characteristics and function as a previously-described element having the same reference designator.

### DETAILED DESCRIPTION

Performing document processing operations directly from a mobile device enables users to avoid the inconvenience of moving documents from the mobile device to a computer suitably adapted to provide document processing requests to an MFP. In many situations, a user may receive a document at his or her mobile device via email. The user may then wish to print or to fax or store that document in a network or cloud location. In other situations, the user interface and processing powers available to a mobile device may provide a better user experience than is available on an MFP. In addition, a user's mobile device may be with them while taking part in meetings, while in his or her office, while at home, and while far from any MFP.

Because mobile devices are typically small, and touch-based, the user interface experiences must be well-designed to avoid screen clutter and to provide good experiences for users. Extraneous settings and options are typically hidden. However, because most mobile devices are capable computing devices, user interfaces can be designed in such a way to make the most important options or the most important options given a particular situation or workflow, most obvious.

Description of Apparatus

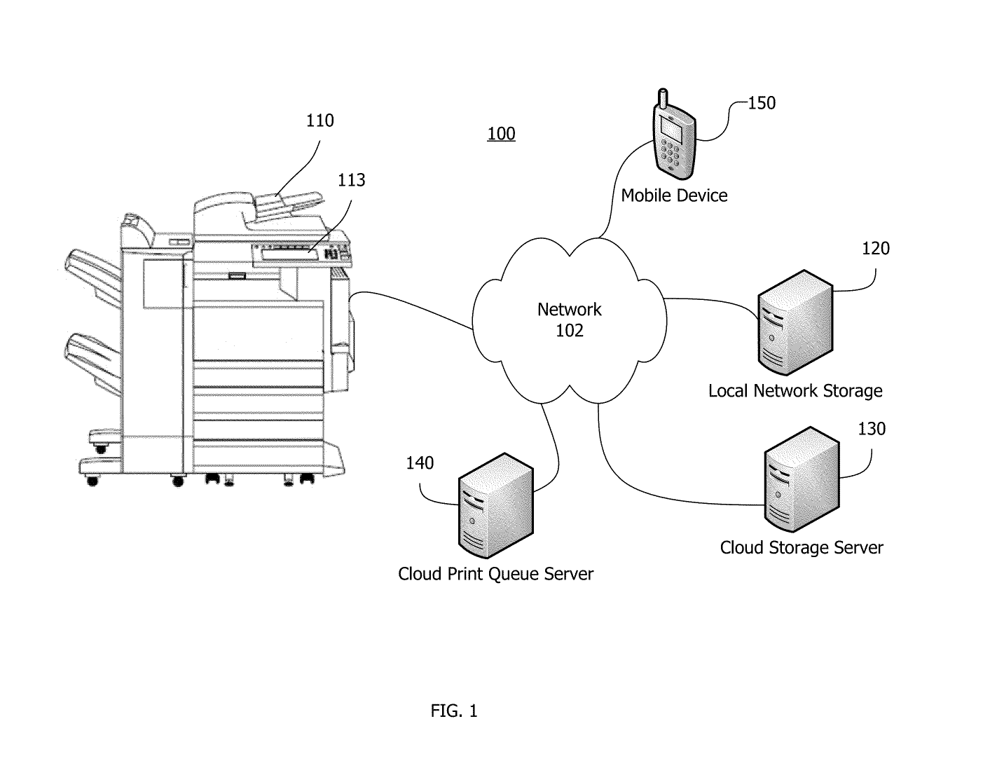

Referring now to FIG. 1 there is shown an MFP system 100. The system 100 includes an MFP 110, local network storage 120, a mobile device 150, a cloud storage server 130, and a cloud print queue server 140, all interconnected by a network 102. The system 100 may be implemented in a distributed computing environment and interconnected by the network 102. An MFP system may include more MFPs, more or fewer servers, and more than one mobile device.

The network 102 may be a local area network, a wide area network, a personal area network, a mobile or telephone network, the Internet, an intranet, or any combination of these. The network 102 may have physical layers and transport layers according to IEEE 802.11, Ethernet or other wireless or wire-based communication standards and protocols such as WiMax®, Bluetooth®, mobile telephone and data protocols, the public switched telephone network, a proprietary communications network, infrared, and optical.

The MFP 110 may be equipped to receive portable storage media such as USB drives. The MFP 110 includes a user interface subsystem 113, which communicates information to and receives selections from users. The user interface subsystem 113 has a user output device for displaying graphical elements, text data or images to a user and a user input device for receiving user inputs. The user interface subsystem 113 may include a touchscreen, LCD display, touch-panel, alpha-numeric keypad and/or an associated thin client through which a user may interact directly with the MFP 110.

The local network storage 120 is software operating on a server computer (or network attached storage) connected to the network 102. The local network storage 120 is a server or servers that store files locally on a network of which the MFP 110 is a part. The local network storage 120 is “local” in that it is not available outside of a local area network or, for example, to individuals outside of an organization.

The cloud storage server 130 is software operating on a server computer connected to the network 102. The cloud storage server 130 is a server or servers that store files remotely from any local area network associated with the MFP 110 or any user. For example, the cloud storage server 130 maybe so-called “cloud” storage providers such as Google® Drive™, Box®, Dropbox® and Microsoft® OneDrive™. A login or other authentication is typically required to access these services. They are typically available via the Internet and may be accessed with the associated authentication.

The cloud print queue server 140 is software operating on a server computer connected to the network 102. The cloud print queue server 140 operates as a print queue that is not stored on an MFP, such as MFP 110 or any computing device associated with a user (such as a desktop computer). The cloud print queue server 140 is accessible via the Internet and stores print jobs that may be released, after a login and identification of a printer to which to release the job, to any printer to which a user has access. Similarly, print jobs may be queued to a cloud print queue server 140 using a login. The print jobs are then stored until released at a particular printer. The release to a printer may, for example, release a print job to a printer remote from a user, using the Internet to deliver the print job, then output at that remote printer.

The mobile device 150 is a mobile or handheld PC, a tablet or smart phone, a feature phone, smart watch, or other similar device. The mobile device 150 is representative of one or more end-user devices and in some cases may not be a part of the MFP system 100.

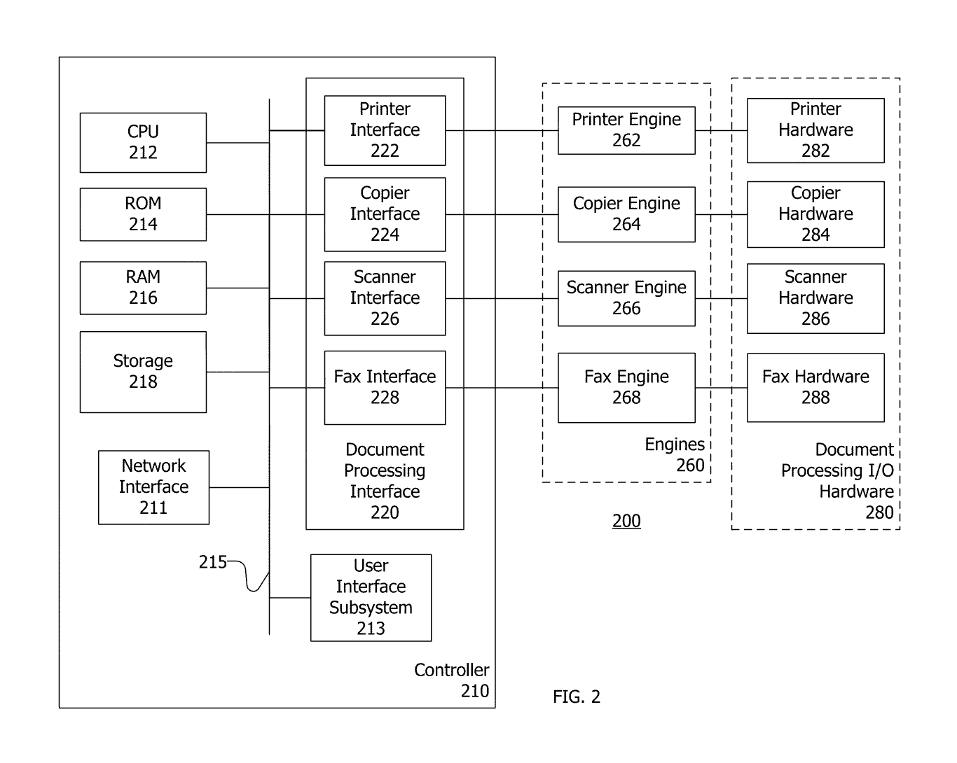

Turning now to FIG. 2 there is shown a block diagram of an MFP 200 which may be the MFP 110 (FIG. 1). The MFP 200 includes a controller 210, engines 260 and document processing I/O hardware 280. The controller 210 includes a CPU 212, a ROM 214, a RAM 216, a storage 218, a network interface 211, a bus 215, a user interface subsystem 213 and a document processing interface 220.

As shown in FIG. 2 there are corresponding components within the document processing interface 220, the engines 260 and the document processing I/O hardware 280, and the components are respectively communicative with one another. The document processing interface 220 has a printer interface 222, a copier interface 224, a scanner interface 226 and a fax interface 228. The engines 260 include a printer engine 262, a copier engine 264, a scanner engine 266 and a fax engine 268. The document processing I/O hardware 280 includes printer hardware 282, copier hardware 284, scanner hardware 286 and fax hardware 288.

The MFP 200 is configured for printing, copying, scanning and faxing. However, an MFP may be configured to provide other document processing functions, and, as per the definition, as few as two document processing functions.

The CPU 212 may be a central processor unit or multiple processors working in concert with one another. The CPU 212 carries out the operations necessary to implement the functions provided by the MFP 200. The processing of the CPU 212 may be performed by a remote processor or distributed processor or processors available to the MFP 200. For example, some or all of the functions provided by the MFP 200 may be performed by a server or thin client associated with the MFP 200, and these devices may utilize local resources (e.g., RAM), remote resources (e.g., bulk storage), and resources shared with the MFP 200.

The ROM 214 provides non-volatile storage and may be used for static or fixed data or instructions, such as BIOS functions, system functions, system configuration data, and other routines or data used for operation of the MFP 200.

The RAM 216 may be DRAM, SRAM or other addressable memory, and may be used as a storage area for data instructions associated with applications and data handling by the CPU 212.

The storage 218 provides volatile, bulk or long term storage of data associated with the MFP 200, and may be or include disk, optical, tape or solid state. The three storage components, ROM 214, RAM 216 and storage 218 may be combined or distributed in other ways, and may be implemented through SAN, NAS, cloud or other storage systems.

The network interface 211 interfaces the MFP 200 to a network, such as the network 102 (FIG. 1), allowing the MFP 200 to communicate with other devices.

The bus 215 enables data communication between devices and systems within the MFP 200. The bus 215 may conform to the PCI Express or other bus standard.

While in operation, the MFP 200 may operate substantially autonomously. However, the MFP 200 may be controlled from and provide output to the user interface subsystem 213, which may be the user interface subsystem 113 (FIG. 1).

The document processing interface 220 may be capable of handling multiple types of document processing operations and therefore may incorporate a plurality of interfaces 222, 224, 226 and 228. The printer interface 222, copier interface 224, scanner interface 226, and fax interface 228 are examples of document processing interfaces. The interfaces 222, 224, 226 and 228 may be software or firmware.

Each of the printer engine 262, copier engine 264, scanner engine 266 and fax engine 268 interact with associated printer hardware 282, copier hardware 284, scanner hardware 286 and facsimile hardware 288, respectively, in order to complete the respective document processing functions.

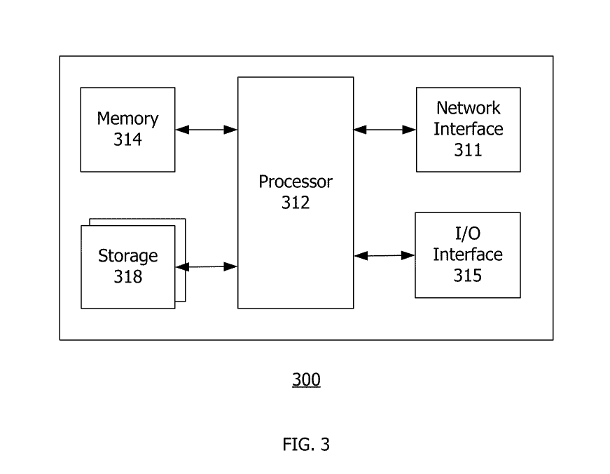

Turning now to FIG. 3 there is shown a computing device 300, which is representative of the server computers, client devices, mobile devices and other computing devices discussed herein. The controller 210 (FIG. 2) may also, in whole or in part, incorporate a general purpose computer like the computing device 300. The computing device 300 may include software and/or hardware for providing functionality and features described herein. The computing device 300 may therefore include one or more of: logic arrays, memories, analog circuits, digital circuits, software, firmware and processors. The hardware and firmware components of the computing device 300 may include various specialized units, circuits, software and interfaces for providing the functionality and features described herein.

The computing device 300 has a processor 312 coupled to a memory 314, storage 318, a network interface 311 and an I/O interface 315. The processor may be or include one or more microprocessors and, application specific integrated circuits (ASICs).

The memory 314 may be or include RAM, ROM, DRAM, SRAM and MRAM, and may include firmware, such as static data or fixed instructions, BIOS, system functions, configuration data, and other routines used during the operation of the computing device 300 and processor 312. The memory 314 also provides a storage area for data and instructions associated with applications and data handled by the processor 312.

The storage 318 provides non-volatile, bulk or long term storage of data or instructions in the computing device 300. The storage 318 may take the form of a disk, tape, CD, DVD, or other reasonably high capacity addressable or serial storage medium. Multiple storage devices may be provided or available to the computing device 300. Some of these storage devices may be external to the computing device 300, such as network storage or cloud-based storage.

The network interface 311 includes an interface to a network such as network 102 (FIG. 1).

The I/O interface 315 interfaces the processor 312 to peripherals (not shown) such as displays, keyboards and USB devices.

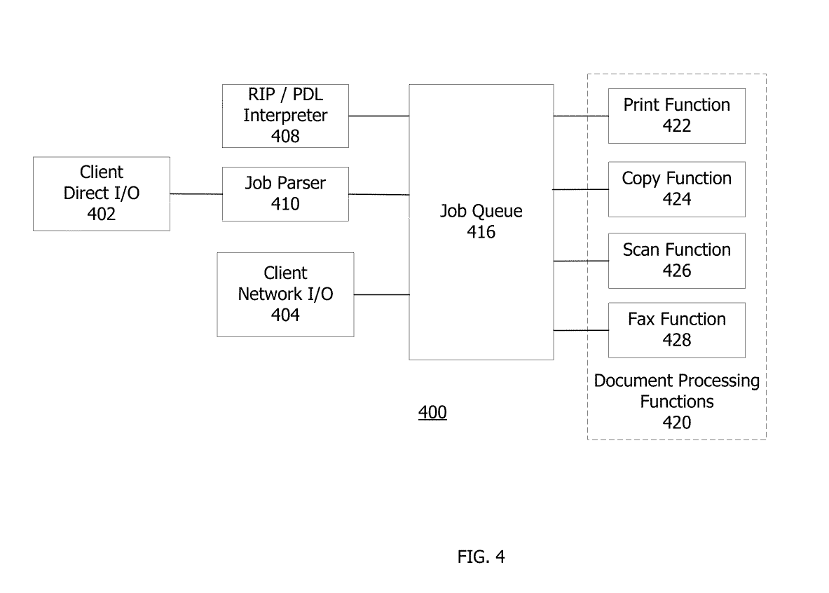

Turning now to FIG. 4 there is shown a block diagram of a software system 400 of an MFP which may operate on the controller 210. The system 400 includes client direct I/O 402, client network I/O 404, a RIP/PDL interpreter 408, a job parser 410, a job queue 416, a series of document processing functions 420 including a print function 422, a copy function 424, a scan function 426 and a fax function 428.

The client direct I/O 402 and the client network I/O 404 provide input and output to the MFP controller. The client direct I/O 402 is for the user interface on the MFP (e.g., user interface subsystem 113), and the client network I/O 404 is for user interfaces over the network. This input and output may include documents for printing or faxing or parameters for MFP functions. In addition, the input and output may include control of other operations of the MFP. The network-based access via the client network I/O 404 may be accomplished using HTTP, FTP, UDP, electronic mail TELNET or other network communication protocols.

The RIP/PDL interpreter 408 transforms PDL-encoded documents received by the MFP into raster images or other forms suitable for use in MFP functions and output by the MFP. The RIP/PDL interpreter 408 processes the document and adds the resulting output to the job queue 416 to be output by the MFP.

The job parser 410 interprets a received document and relays it to the job queue 416 for handling by the MFP. The job parser 410 may perform functions of interpreting data received so as to distinguish requests for operations from documents and operational parameters or other elements of a document processing request.

The job queue 416 stores a series of jobs for completion using the document processing functions 420. Various image forms, such as bitmap, page description language or vector format may be relayed to the job queue 416 from the scan function 426 for handling. The job queue 416 is a temporary repository for all document processing operations requested by a user, whether those operations are received via the job parser 410, the client direct I/O 402 or the client network I/O 404. The job queue 416 and associated software is responsible for determining the order in which print, copy, scan and facsimile functions are carried out. These may be executed in the order in which they are received, or may be influenced by the user, instructions received along with the various jobs or in other ways so as to be executed in different orders or in sequential or simultaneous steps. Information such as job control, status data, or electronic document data may be exchanged between the job queue 416 and users or external reporting systems.

The job queue 416 may also communicate with the job parser 410 in order to receive PDL files from the client direct I/O 402. The client direct I/O 402 may include printing, fax transmission or other input of a document for handling by the system 400.

The print function 422 enables the MFP to print documents and implements each of the various functions related to that process. These include stapling, collating, hole punching, and similar functions. The copy function 424 enables the MFP to perform copy operations and all related functions such as multiple copies, collating, 2 to 1 page copying or 1 to 2 page copying and similar functions. Similarly, the scan function 426 enables the MFP to scan and to perform all related functions such as shrinking scanned documents, storing the documents on a network or emailing those documents to an email address. The fax function 428 enables the MFP to perform facsimile operations and all related functions such as multiple number fax or auto-redial or network-enabled facsimile.

Some or all of the document processing functions 420 may be implemented on a client computer, such as a personal computer or thin client. The user interface for some or all document processing functions may be provided locally by the MFP's user interface subsystem though the document processing function is executed by a computing device separate from but associated with the MFP.

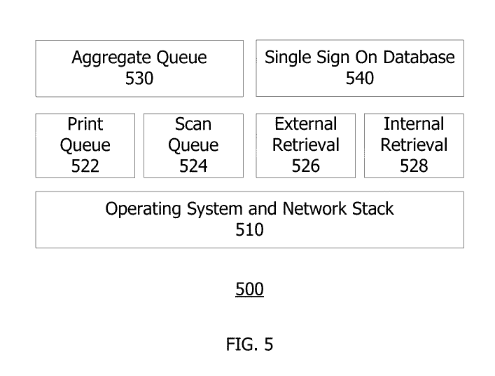

Turning now to FIG. 5, a block diagram of an aggregate queue software system 500 is shown. The aggregate queue software system 500 may operate on a computing device 300, such as the controller 210, a mobile device 150 or one of the servers shown in FIG. 1. The aggregate queue software system 500 includes an operating system and network stack 510, a print queue 522, a scan queue 524, external retrieval module 526, internal retrieval module 528, an aggregate queue 530 and a single sign on database 540.

The operating system and network stack 510 are the baseline software that enables overall operation of the aggregate queue software system 500 and the network stack that enables network-based communications with external systems and computing devices. The print queue 522 is a local print queue (for example, an MFP's print queue, a computer's print queue or a mobile device print queue) that temporarily stores documents that are to be output via printing. The scan queue 524 is similar to the print queue 522, but it stores scan jobs before they are output to a storage location (local or network).

The external retrieval system 526 is a series of application programming interfaces or other so-called “connectors” that enable the aggregate queue software system 500 to access one or more network or “cloud” services. For example, the external retrieval system 526 may act as a connector handling all data interchanges between a cloud service, such as Google® Drive™, that enable the aggregate queue software system 500 to obtain data from the service or store data to the service. The external retrieval system 526 may interact with any “external” sources such as remote shares, cloud services, cloud print queues and other, similar, services.

The internal retrieval system 528 interacts with more traditional network interfaces, such as Windows® shared drives, local network attached storage devices, Linux devices and the like to authenticate and thereafter to obtain data from a storage location or store data to a storage location. Similarly, the internal retrieval system 528 may interact with local print servers, other MFPs, and other, “local” devices that have data or are locations to store data. The sources from which the internal retrieval system 528 are not generally available to those outside of an organization.

The aggregate queue 530 combines all of the data sources, the print queue 522, and any external sources and internal sources (obtained using the external retrieval system 526 and internal retrieval system 528) into a single queue. This single queue is the aggregate queue 530 of the aggregate queue software system 500.

The single sign on database 540 is a stored data set identifying a plurality of data sources and associated authentication credentials suitable for accessing any of the data sources. Specifically, the single sign on database 540 is associated with a set of authentication credentials, such as a username and password, an RFID card, a fingerprint scanner, a set of RSA keys, or other, similar authentication credentials, that also stores additional authentication credentials for accessing other services and servers.

A single sign on database 540, for example, may require a complex password and challenge questions. Once received, the database may be decrypted to gain access to a plurality of credentials, both local network credentials (to access network storage locations) and so-called “cloud” print services, such as cloud print queues and cloud storage locations. The aggregate queue software system 500 may then use the retrieval systems 526 and 528 in conjunction with the database 540 to access associated services.

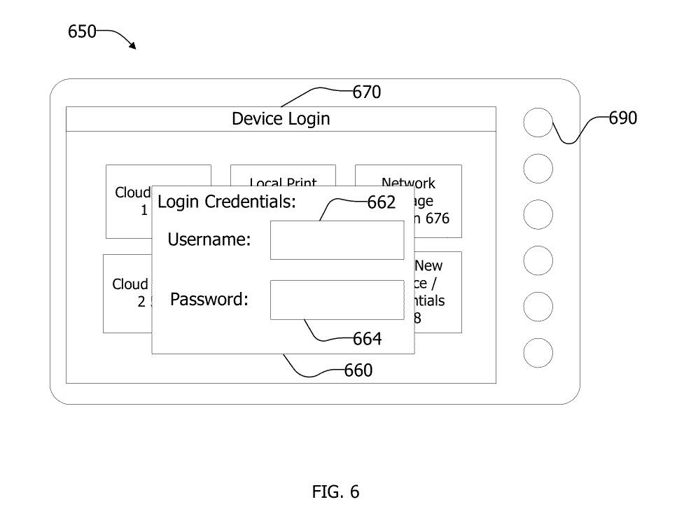

FIG. 6 is a multifunction peripheral user interface 650 showing a single sign on process. The interface 650 includes a login screen 660, a header bar 670, and some hardware buttons, including hardware button 690.

The login screen 660 includes username 662 and password 664 blanks typical for inputting a username and password for authentication. Although this process is shown, authentication may take place by any number of other methods, such as and RFID key, a swipeable keycard, a fingerprint scanner, a username and PIN, an RSA authenticator code, and still other methods.

The device login header bar 670 makes clear that a login is required to proceed.

The hardware buttons, like hardware button 690 may perform various functions on the MFP.

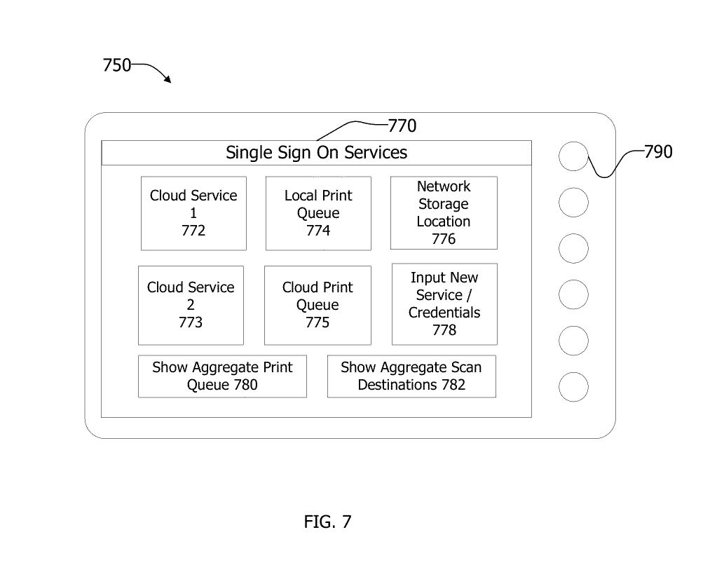

Turning to FIG. 7, a multifunction peripheral user interface 750 showing available services as a result of the single sign on process is shown. This user interface 750 is shown after a user signs on using the single sign on shown in FIG. 6. The header 770 indicates that these are single sign on services and the hardware button 790's function is discussed above.

A series of buttons on the user interface 750 identify the available services associated with the single sign on service. Specifically, buttons associated with the cloud service 1 772 and cloud service 2 773 are shown along with the local print queue 774 and cloud print queue 775, the network storage location 776 and the input new service/credentials 778. In addition, buttons associated with showing the aggregate print queue 780 and showing the aggregate scan destinations 782 are shown. More or fewer buttons may be included dependent only on the number of authentication credentials that the user has added to the account associated with the single sign on.

Cloud service 1 772 and cloud service 2 773 buttons identify two cloud services (for example, Google® Drive™ and Microsoft® OneDrive™) that are currently associated with the single sign on. Activating these buttons may enable a process of editing the credentials associated with those services, deleting those services from the single sign on system or otherwise updating or altering those credentials. The buttons are a convenient way to see which services are currently available. Additional cloud services or fewer may be set up and associated with a single sign on.

The local print queue 774 button shows that the single sign on includes access to a local print queue, for example, the print queue on the MFP. Selecting the local print queue 774 button may enable a user to disable access to the local print queue, at least from the single sign on interface. Doing so will cause documents from the local print queue to stop appearing in the aggregate print queue. Additionally, there may be a series of local print queues 774, including those from nearby MFPs, a print server or multiple print queues (secured and not) on a single MFP.

The cloud print queue 775 button indicates that at least one cloud print queue 775 is associated with the single sign on used to authenticate to the MFP. This may be, for example, Google® Cloud Print™. The presence of this button indicates that there are authentication credentials input associated with that cloud print queue 775. Accessing the button enables a user to update the credentials, delete the credentials or access other settings related to the cloud print queue 775.

The network storage location 776 button indicates that at least one network storage location 776 is present. This may, in fact, be a series of network storage locations, such as a series of folders or network drives, particularly if they all require a single set of authentication credentials. Additional network storage location 776 buttons may be added for additional locations requiring different authentication credentials.

The input new service/credentials 778 button enables a user to input a new set of credentials for an internal or external source.

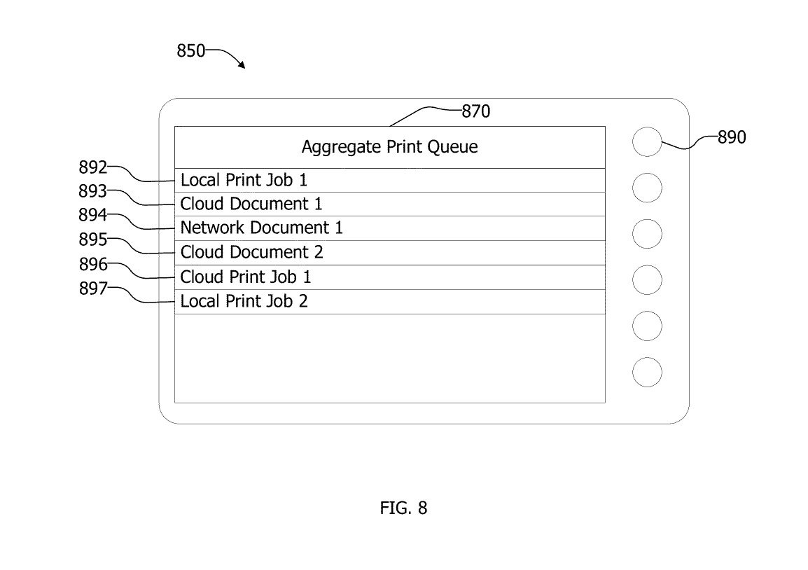

Interacting with the show aggregate print queue 780 button updates the user interface 750 to show the aggregate print queue. This is shown and discussed more fully below with respect to FIG. 8.

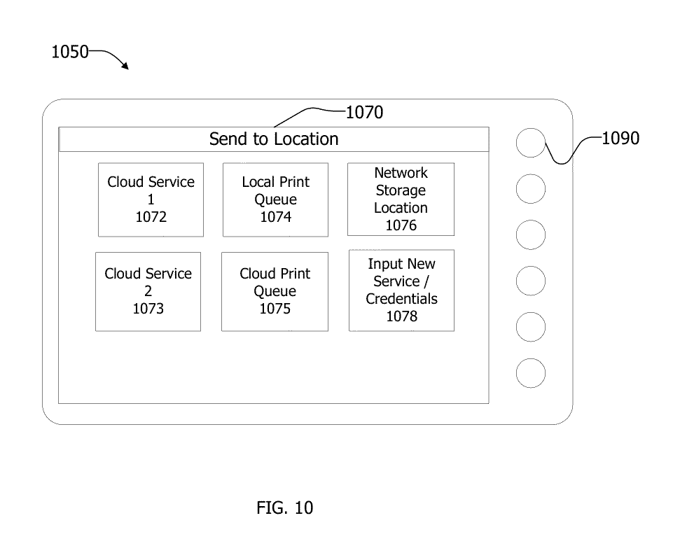

The show aggregate scan destinations 782 button updates the user interface 750 to show the aggregate scan locations. This is shown and discussed more fully below with respect to FIG. 10.

Referring to FIG. 8, a multifunction peripheral user interface 850 showing an aggregate print queue is shown. The header 870 of the user interface 850 indicates that this is the aggregate print queue. The hardware button 890's function is discussed above with respect to FIG. 6. This user interface 850 is displayed after user interaction with the show aggregate print queue 780 button in FIG. 7.

The local print job 1 892, cloud document 1 893, network document 1 894, cloud document 2 895, cloud print job 1 896 and local print job 2 897 are, collectively, a listing of available print jobs that may be performed. The local print job 1 892 is a recent print job that was sent directly to the local print queue for the MFP.

The cloud document 1 893 is a document available on a cloud service that has not necessarily even been sent to a printer. It may be, for example, the most-recently interacted with document stored on one of the cloud services associated with the single sign on credentials.

Network document 1 894 may be a document stored in a local network storage location. It, also, may not have been sent to a print queue for any MFP, but may be accessible via the aggregate print queue.

Cloud document 2 895 may be another document stored on a cloud storage service available via credentials stored in association with the single sign on credentials.

The cloud print job 1 896 may be a print job that was sent to a cloud print queue and that may be retrieved by the MFP using stored credentials associated with the cloud print service.

The local print job 2 897 may be a print job sent to the local MFP queue. It may be shown lower on the list because the other documents were accessed, stored, or saved more recently.

As mentioned above, the ordering of the documents in the aggregate print queue may be based upon the most recent interaction with the document. So, if a user sends a print job to a local MFP queue, then waits several hours while interacting with other documents stored in a cloud service, on a network or sent to a cloud print queue, the local MFP print queue may not take precedence in the aggregate print queue. Instead, the document or print job with the most recent time stamp may be shown first, even in situations where the user has not yet requested printing of that document (cloud services, local network storage, etc.).

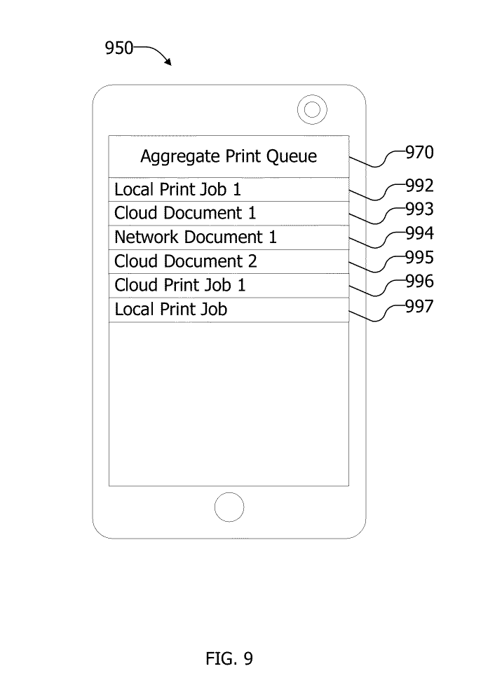

FIG. 9 is a mobile device user interface 950 showing an aggregate print queue. The header 970 indicates that this is an aggregate print queue. The same set of the local print job 1 992, cloud document 1 993, network document 1 994, cloud document 2 995, cloud print job 1 996 and local print job 2 997 are representative of the same print jobs and potential print jobs. The description will not be repeated here.

FIG. 9 is shown in order to demonstrate that the system herein is not limited to operation on the user interface of an MFP, but may be initiated and completed from a mobile device. In such a case, an MFP may be first selected in order to populate the “local” print queues and storage. Alternatively, the mobile device itself may have a print queue or none may be shown. Regardless, the single sign on credentials may follow a user such that a user logging into a mobile device is presented with the same set of potential document sources as an individual logging into an MFP or to a similar interface on a personal computer.

Turning now to FIG. 10, a multifunction peripheral user interface showing “send to locations” 1070, which is to say destinations for scanned documents. This user interface 1050 is displayed after user interaction with the show aggregate scan destinations 782 button in FIG. 7. The user interface buttons correspond to those shown in FIG. 8, but are locations to which scan jobs may be sent.

For example, the cloud service 1 1072 and cloud service 2 1073 buttons enable a user to transmit a scanned document to either service. The local print queue 1074 button enables a user to transmit a scanned document to the local print queue for output. The cloud print queue 1075 button enables a user to send a scanned document to a cloud print service. The network storage location 1076 button enables a user to select a network storage location to which to store the scanned document. Finally, the input new service/credentials 1078 button enables a user to identify a new location.

Description of Processes

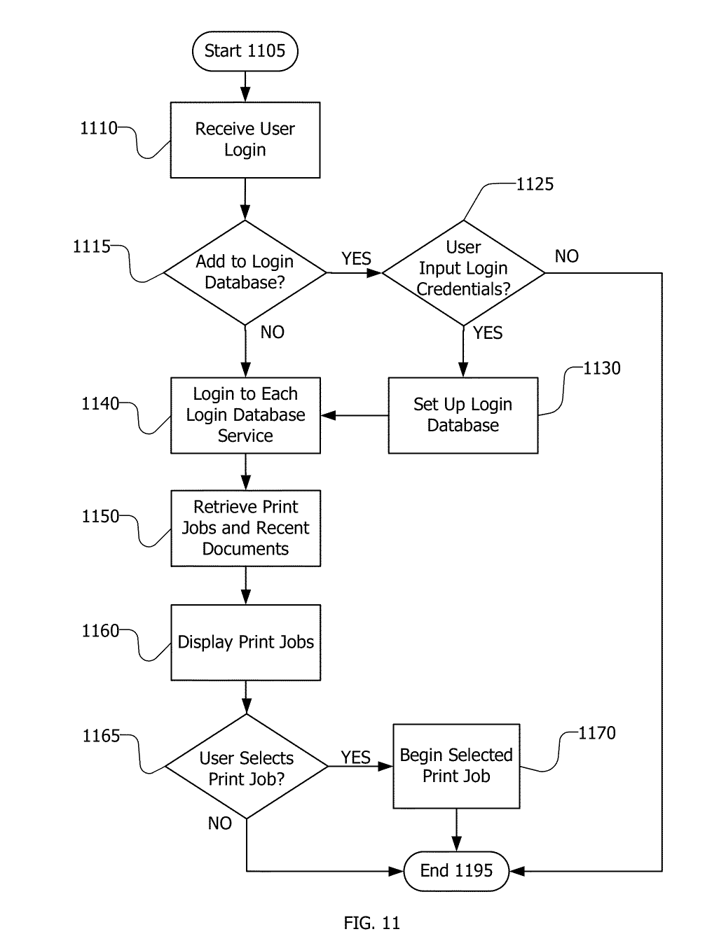

Turning to FIG. 11, a flowchart showing the process of aggregating print operations is shown. The process begins at start 1105 and ends at end 1195, but may take place many times over. The process may take place directly on the user interface of an MFP or may use, in part, a mobile device to perform some of the steps in the process.

After the start 1105, the process begins by receiving a user login at 1110. This login may be typical username and password credentials or may involve a card swipe, an RFID-enabled card system, a username and pin, an RSA two-stage authentication process or other, similar interaction.

Once the authentication credentials are accepted, they may be confirmed by the MFP or by a remote authentication server. In the latter case, the credentials may be associated with user settings, including a login database (discussed below) storing a series of other credentials that may be used to access several different types of systems and services.

Once authenticated at 1110, a determination is made whether to add to the associated login database at 1115. If yes, (“Yes” at 1115), then a user may input login credentials for any number of services, such as cloud storage services, local storage, cloud print queues, and similar services at 1125. The associated login database including these entries is set up at 1130. This login database includes all credentials associated with the user login confirmed at 1110.

These credentials, once input (or if already present, “no” at 1115) may be used to login to each login database service at 1140. In such a situation, all of the relevant services, print queues, storage locations and the like are simultaneously accessed using the stored credentials in the login database.

Next, the print documents in any print queue, local or “cloud,” and the recently-accessed documents in any local, network, or “cloud” server are retrieved at 1150. In this way, the list of aggregate print jobs is populated for display at 1160.

If the user selects to print one of the jobs (“yes” at 1165), then the selected print job is begun at 1170. This process may merely involve release from a print queue or may involve conversion of a document from a storage location into a printer-ready document before output may be completed. Whatever the case, the relevant MFP is identified for output and the process is begun at 1170.

If the user does not select a print job (“no” at 1165) or once the process is complete, then the process ends at 1195.

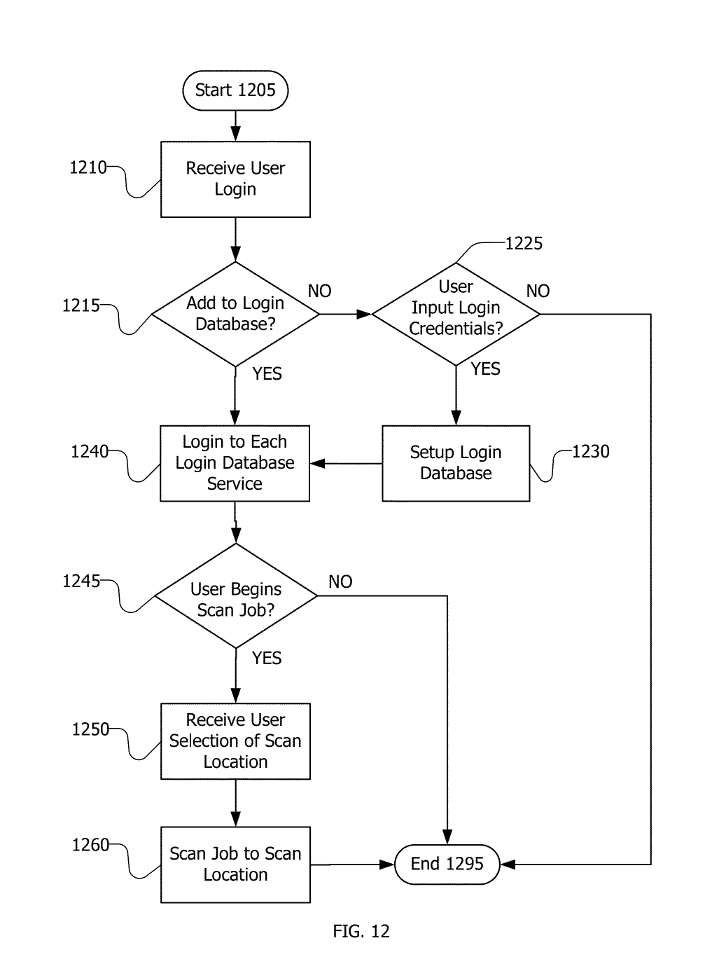

Turning now to FIG. 12, a flowchart showing the process of aggregating scan operations is shown. The process begins at start 1205 and ends at end 1295, but may take place many times over. The process may take place directly on the user interface of an MFP or may use, in part, a mobile device to perform some of the steps in the process.

After the start 1205, the process begins by receiving a user login at 1210. This login may be typical username and password credentials or may involve a card swipe, an RFID-enabled card system, a username and pin, an RSA two-stage authentication process or other, similar interaction.

Once the authentication credentials are accepted, they may be confirmed by the MFP or by a remote authentication server. In the latter case, the credentials may be associated with user settings, including a login database (discussed below) storing a series of other credentials that may be used to access several different types of systems and services.

Once authenticated at 1210, a determination is made whether to add to the associated login database at 1215. If yes, (“Yes” at 1215), then a user may input login credentials for any number of services, such as cloud storage services, local storage, cloud print queues, and similar services at 1225. The associated login database including these entries is set up at 1230. This login database includes all credentials associated with the user login confirmed at 1210.

These credentials, once input (or if already present, “no” at 1215) may be used to login to each login database service at 1240. In such a situation, all of the relevant services, print queues, storage locations and the like are simultaneously accessed using the stored credentials in the login database.

Next, the user must elect whether to begin the scan job at 1245. As a part of that scan job, the user must indicate a destination to which the resulting document will be stored or sent at 1250. This destination may be any one of the locations or services that were accessed in step 1240. For example, the scan may be directed to a cloud storage location, to a local storage, to a network storage location, to a cloud storage location, to a cloud print service, to the local print queue or to a remote print queue. Any service that the user has suitable credentials and that the MFP was capable of accessing using those credentials at 1240 may be available as a scan destination.

To allow the user to select a destination for the resulting document, an aggregate destination screen, as shown in FIG. 10, may be displayed at 1250. Once the user has identified the scan location at 1250, the scan operation is completed and the scan job is sent to the scan destination at 1260. This may involve print output in the case of cloud or local print queues or may merely involve the storage of the document to a network, local, or cloud location.

If the user does not select a scan job (“no” at 1245) or once the process is complete at 1260, then the process ends at 1295.

### CLOSING COMMENTS

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

1. A method for aggregating print operations comprising:
receiving a single login via a user interface, the single login associated with a login database;
automatically performing login operations using data stored in the login database for at least a network storage location and a network print queue;
searching for print jobs stored in the network print queue and for stored documents available on the network storage location;
displaying the print jobs and stored documents on a display as an aggregate print queue;
accepting user selection of a document from the aggregate print queue;
beginning print output of the selected document on a multifunction peripheral.

2. The method of claim 1 wherein the network print queue is a public network print queue for storing documents prior to their release for output.

3. The method of claim 1 wherein the network storage location is a cloud storage service.

4. The method of claim 1 wherein the network storage location is one of a web-based sharing platform or a server on a local network.

5. The method of claim 1 wherein the aggregate print queue shows a listing of documents, ordered from most recently-acted-upon to least-recently-acted-upon, that may be output by the multifunction peripheral.

6. The method of claim 1 wherein searching for print jobs includes searching at least one internal network location, at least one public network location, a print queue local to the multifunction peripheral, and the network print queue.

7. An apparatus comprising:
a user interface for receiving a single login to a multifunction peripheral capable of completing a print operation;
a controller for automatically performing login operations using a login database associated with the single login for at least a network storage location and a network print queue and for searching for print jobs stored in the network print queue and for stored documents available on the network storage location;
the user interface further for displaying the print jobs and stored documents on a display as an aggregate print queue and accepting user selection of a document from the aggregate print queue;
the controller further for beginning the print operation of the selected document on the multifunction peripheral.

8. The apparatus of claim 7 wherein the network print queue is a public network print queue for storing documents prior to their release for output.

9. The apparatus of claim 7 wherein the network storage location is a cloud storage service.

10. The apparatus of claim 7 wherein the network storage location is one of a web-based sharing platform or a server on a local network.

11. The apparatus of claim 7 wherein the aggregate print queue shows a listing of documents, ordered from most recently-acted-upon to least-recently-acted-upon, that may be output by the multifunction peripheral.

12. The apparatus of claim 7 wherein searching for print jobs includes searching at least one internal network location, at least one public network location, a print queue local to the multifunction peripheral, and the network print queue.

13.-18. (canceled)

19. The apparatus of claim 7 wherein the apparatus comprises the multifunction peripheral.

20. The apparatus of claim 7 wherein the apparatus comprises a mobile device.
